(19) United States
(12) Patent Application Publication
(10) Pub. No.: US 2024/0243321 A1
(43) Pub. Date: Jul. 18, 2024

(54) METHOD OF SEALING ACID-DOPED MEMBRANES

(71) Applicant: JTEC ENERGY, INC., Atlanta, GA (US)

(72) Inventor: Dorcelle Lotemo, Atlanta, GA (US)

(21) Appl. No.: 18/413,415

(22) Filed: Jan. 16, 2024

Related U.S. Application Data
(60) Provisional application No. 63/438,882, filed on Jan. 13, 2023.

(51) Int. Cl. H01M 8/103; H01M 8/10

(52) U.S. Cl. CPC H01M 8/103; H01M 2008/1095

(57) ABSTRACT

A method of bonding two or more acid-doped polybenzimidazole films includes attaching pairs of first and second substrates to opposing surfaces of respective first and second acid-doped polybenzimidazole films to form first and second film/substrate assemblies. A portion of each of the first and second acid-doped polybenzimidazole films is uncovered by the respective first and second substrates. The method further includes submerging at least the uncovered portions of the first and second films in a solvent to remove acid therefrom, spraying a fluoroelastomer coating on at least one section of each of the uncovered portions of the first and second films, positioning the second film/substrate assembly atop the first film/substrate assembly and bringing the spray coated sections of the first and second films into contact with each other, and applying at least one of pressure or heat to the contacted sections of the first and second films.

### CROSS-REFERENCE TO RELATED APPLICATIONS

This application claims the benefit of U.S. Provisional Patent Application No. 63/438,882, filed on Jan. 13, 2023, entitled “Method of Sealing Acid-Doped Membranes,” currently pending, the entire contents of which are incorporated by reference herein.

### BACKGROUND

The conversion of heat energy or chemical energy to electrical energy, or visa-versa, may be accomplished in a variety of ways. For example, known electrochemical cells or batteries rely on chemical reactions, wherein ions and electrons of a reactant which is being oxidized are transferred to the reactant which is being reduced via separate paths. Specifically, the electrons are transferred electrically via wiring through an external load where they perform work, while the ions are conducted through an electrolyte separator.

However, battery-type electrochemical cells can produce only a limited amount of energy, because the confines of the battery casing limit the amount of available reactants that may be contained therein. Although such electrochemical cells can be designed to be recharged by applying a reverse polarity current/voltage across the electrodes, such recharging requires a separate electrical source. Also, during the recharging process, the electrochemical cell is typically not usable.

Fuel cells have been developed in an effort to overcome problems associated with battery-type electrochemical cells. In conventional fuel cells, the chemical reactants are continuously supplied to and removed from the electrochemical cell. In a manner similar to batteries, fuel cells operate by conducting an ionized species through a selective electrolyte within a membrane electrode assembly (MEA) which generally blocks the passage of electrons and non-ionized species.

The most common type of fuel cell is a hydrogen-oxygen fuel cell which passes hydrogen through one of the electrodes and passes oxygen through the other one of the electrodes. Porous electrodes on either side of the electrolyte separator membrane are used to couple the electrons involved in the chemical reaction to an external load via an external circuit. The hydrogen ions are conducted through the electrolyte separator to the oxygen side of the cell under the chemical reaction potential of hydrogen and oxygen. On the oxygen side, the electrons and hydrogen ions reconstitute hydrogen and complete the reaction with oxygen, resulting in the production of water which is expelled from the system. A continuous electrical current as hydrogen and oxygen are continuously supplied to the cell.

Mechanical heat engines have also been designed and used to produce electrical power. Such mechanical heat engines operate on thermodynamic cycles, wherein shaft work is performed using a piston or turbine to compress a working fluid. The compression process is performed at a low temperature and, after compression, the working fluid is raised to a higher temperature. At the high temperature, the working fluid is allowed to expand against a load, such as a piston or turbine, thereby producing shaft work. A key to the operation of all engines employing a working fluid is that less work is required to compress the working fluid at low temperatures than that produced by expanding it at high temperatures. This is the case for all thermodynamic engines employing a working fluid.

For example, steam engines operate on the Rankine thermodynamic cycle, wherein water is pumped to a high pressure, and then heated to steam and expanded through a piston or turbine to perform work. Internal combustion engines operate on the Otto cycle, wherein low temperature ambient air is compressed by a piston and then heated to very high temperatures via fuel combustion inside the cylinder. As the cycle continues, the expansion of the heated air against the piston produces more work than that consumed during the lower temperature compression process.

The Stirling engine has been developed to operate on the Stirling cycle in an effort to provide an engine that has high efficiency and offers greater versatility in the selection of the heat source. The ideal Stirling thermodynamic cycle is of equivalent efficiency to the ideal Carnot cycle, which defines the theoretical maximum efficiency of an engine operating on heat input at high temperatures and heat rejection at low temperatures. However, as with all mechanical engines, the Stirling engine suffers from reliability problems and efficiency losses associated with its mechanical moving parts.

In an effort to avoid the problems inherent with mechanical heat engines, Alkali Metal Thermo-Electrochemical Conversion (AMTEC) cells have been designed as a thermo-electrochemical heat engine. AMTEC heat engines utilize pressure to generate a voltage potential and electrical current by forcing an ionizable working fluid, such as sodium, through an electrochemical cell (membrane electrode assembly, MEA) at high temperatures. The electrodes couple the electrical current to an external load. Electrical work is performed as the pressure differential across the electrolyte separator forces molten sodium atoms through the electrolyte. The sodium is ionized upon entering the electrolyte, thereby releasing electrons to the external circuit. On the other side of the electrolyte, the sodium ions recombine with the electrons to reconstitute sodium upon leaving the electrolyte, in much the same way as the process that occurs in battery and fuel cell type electrochemical cells. The reconstituted sodium, which is at a low pressure and a high temperature, leaves the electrochemical cell as an expanded gas. The gas is then cooled and condensed back to a liquid state. The resulting low-temperature liquid is then re-pressurized. Operation of an AMTEC engine approximates the Rankine thermodynamic cycle.

Numerous publications are available on AMTEC technology. See, for example, Conceptual design of AMTEC demonstrative system for 100 t/d garbage disposal power generating facility, Qiuya Ni et al. (Chinese Academy of Sciences, Inst. of Electrical Engineering, Beijing, China). Another representative publication is Intersociety Energy Conversion Engineering Conference and Exhibit (IECEC), 35th, Las Vegas, NV (Jul. 24-28, 2000), Collection of Technical Papers. Vol. 2 (A00-37701 10-44). Also see American Institute of Acronautics and Astronautics, 190, p. 1295-1299. REPORT NUMBER(S)—AIAA Paper 2000-3032.

AMTEC heat engines suffer from reliability issues due to the highly corrosive nature of the alkali metal working fluid. AMTEC engines also have very limited utility. Specifically, AMTEC engines can only be operated at very high temperatures because ionic conductive solid electrolytes achieve practical conductivity levels only at high temperatures. Indeed, even the low-temperature pressurization process must occur at a relatively high temperature, because the alkali metal working fluid must remain above its melt temperature at all times as it moves through the cycle. Mechanical pumps and even magneto-hydrodynamic pumps have been used to pressurize the low-temperature working fluid.

In an effort to overcome the above-described drawbacks of conventional mechanical and thermo-electrochemical heat engines, the Johnson Thermo-Electrochemical Converter (JTEC) system, which can approximate a Carnot equivalent cycle (disclosed in U.S. Pat. No. 7,160,639 filed Apr. 28, 2003, the entire contents of which are incorporated herein by reference), was invented. The typical JTEC system is a heat engine that includes a first electrochemical cell (MEA) operating at a one temperature, a second electrochemical cell (MEA) operating at a different temperature from the first, a conduit system including a heat exchanger that couples the two cells together, and a supply of ionizable gas (such as hydrogen or oxygen) as a working fluid contained within the conduit system. Each MEA stack includes a non-porous membrane capable of conducting ions of the working fluid with porous electrodes positioned on opposite sides.

In the JTEC, working fluid passes through each MEA stack by releasing an electron to the electrode on the entering side, such that the ions (protons) can be conducted through the membrane to the opposite electrode. The working fluid is reconstituted within the opposite electrode as it re-supplies electrons to working fluid ions as they exit the membrane, the electrons having passed through an external load or controller. If a hydrogen pressure differential is applied across an MEA having an electrical load attached, it will supply power to the load as hydrogen passes from high pressure to low pressure. The process also operates in reverse. Voltage and current can be applied to an MEA to pump hydrogen from low pressure to high pressure.

Operating under a pressure differential, the high temperature cell will have a higher voltage than the low temperature cell, consistent with the Nernst equation. As in any other engine, the working fluid, hydrogen in this case, is compressed a low temperature and expanded at high temperature to produce net power output. Consistent current through both MEAs maintains a constant pressure differential. Since the current (I) is the same through both cells, the voltage differential means that the power generated through the expansion of hydrogen in the high temperature cell is higher than that of the low temperature cell.

A number of challenges have been encountered with developing a JTEC that is suitable for widespread use, particularly related to the issues associated with using hydrogen as a working fluid. For example, hydrogen leakage through small defects in the conduit system may occur due to the small size of the hydrogen molecule. In particular, hydrogen leakage can occur at the interconnection joints of the conduit couplings between the high-temperature cell and the low temperature cell. Such leakage is undesirable in that it reduces the pressure differential of the working fluid across the membrane and in that so reduces the electrical output and overall system efficiency.

Further, unlike conventional fuel cells, where the open circuit voltage can be greater than one volt, the Nernst voltage from the hydrogen pressure differential across an MEA stack is in the range of only about 0.2 Volts. As such, many cells will have to be connected in series to achieve useful output voltage levels. In addition, each JTEC cell needs to have a large membrane/electrode surface area in order to achieve useful levels of output current and minimum voltage loss due to membrane resistance. That is, considering the low operating voltages of individual cells and the low conductivity of available membrane materials, large membrane surface areas are needed to produce useful levels of power. A direct-bonded membrane structure would alleviate the aforementioned challenges related to hydrogen leakage by eliminating conduit couplings, which are prone to leakage.

As such, membranes, like those used in thermoelectric engines, need to have sufficiently high ion conductivity to maximize output voltage as well as high diffusion barrier properties to minimize pressure-induced diffusion of working fluid, such as hydrogen gas or any gas with an accompanied conductor (e.g., oxygen), across the membrane and the reduction in electrical output and efficiency associated with it. However, available hydrogen ion conductive membrane materials that have useful ion conductivity, such as Nafion, a polymer manufactured by the DuPont Corp., generally have very poor molecular diffusion barrier properties and result in loss of the pressure differential required for operation. Conversely, available membrane materials such as ceramic ion conductors that have high molecular diffusion barrier properties generally have relatively low ionic conductivity, particularly at low to moderate temperatures and use of such materials would result in high system impedance and high polarization losses. Accordingly, there is a need for a practical way of using available high barrier, high ion or proton conductivity materials as thin, large surface area membranes, in order to provide a thermo-electrochemical heat engine that can approximate a Carnot equivalent cycle and that eliminates the reliability and inefficiency problems associated with conventional mechanical engines.

For this reason, interest in the use of solid polymer electrolytes has grown immensely. Unlike conventional alternative membrane materials, such as Nafion® whose conductivity is dependent upon water availability and thus requires external humidification for optimal operation, the proton conductivity of solid polymer electrolytes is not dependent on water availability, and thus they operate at high temperatures without external humidification. For that, one membrane of particular interest for solid polymer electrolytes is based on polybenzimidazole (PBI) polymers. PBI polymers are a group of polymers renowned for their excellent thermal and chemical stability. More particularly, PBI inherently has high thermal and chemical stability due to its aromatic structure and strong and rigid nature of the aromatic structure's bonds

Methods have been developed to make PBI solutions from which thin membranes can be cast. Specifically, PBI films can be used as a solid polymer electrolyte by casting the membrane from a solution, and then doping the membrane in phosphoric acid (PA) to make the polymer proton conductive. See, e.g., J. S. Wainright et al., “Acid-doped polybenzimidazoles: a new polymer electrolyte,” Journal of the Electroochemical Society, 142(7) (1995).

Xiao et al. developed a sol-gel process called the “PPA process” (polyphosphoric acid process), in which PA-doped PBI membranes can be synthesized (see, e.g., L. Xiao et al., “High-temperature polybenzimidazole fuel cell membranes via a sol-gel process,” Chemistry of Materials, 17(21), 5328-333 (2005)). Acid-doped gel membranes synthesized via the polyphosphoric acid (PPA) process have a high acid content per repeat unit of polymer, which results in high proton conductivity and in the membrane retaining mechanical properties of a degree that enable the polymer to be used in fuel cell applications. Thus, acid-doped PBI membranes would be particularly desirable for use in fuel cell applications. One of the limits of an acid-doped PBI-based membrane, however, is that it does not readily bond to itself as well as other materials. Thus, it becomes difficult to bond together to PBI membranes to form subassemblies used to make an electrochemical cell stack. Therefore, it is desirable to provide a method for efficiently bonding together acid-doped PBI membranes.

### BRIEF SUMMARY

Briefly stated, one embodiment comprises a method of bonding two or more acid-doped polybenzimidazole films. The method includes attaching a pair of first substrates to opposing surfaces of a first acid-doped polybenzimidazole film to form a first film/substrate assembly. A portion of the first acid-doped polybenzimidazole film is uncovered by the first substrates. The method further includes attaching a pair of second substrates to opposing surfaces of a second acid-doped polybenzimidazole film to form a second film/substrate assembly. A portion of the second acid-doped polybenzimidazole film is uncovered by the second substrates. The method further includes submerging at least the uncovered portions of the first and second acid-doped polybenzimidazole films in a solvent to remove acid from at least the uncovered portions of the first and second acid-doped polybenzimidazole films; spraying a fluoroelastomer coating on at least one section of each of the uncovered portions of the first and second acid-doped polybenzimidazole films, positioning the second film/substrate assembly atop the first film/substrate assembly and bringing the spray coated sections of the uncovered portions of the first and second acid-doped polybenzimidazole films into contact with each other, and applying at least one of pressure or heat to the contacted sections of the uncovered portions of the first and second acid-doped polybenzimidazole films.

In one aspect, the solvent is deionized water. In a further aspect, the deionized water is at room temperature and the submerging step is performed for at least about forty seconds.

In another aspect, the step of applying at least one of pressure or heat includes applying pressure to the contacted sections for a period of about 24-48 hours.

In yet another aspect, the step of applying at least one of pressure or heat includes applying a hot press at a temperature of about 60° C. for about three minutes.

In still another aspect, the method further includes, after the attaching step but before the submerging step, heating the first and second film/substrate assemblies at a temperature of about 180° C. for about forty-five minutes.

In yet another aspect, the method further includes, after the spraying step, drying the first and second film/substrate assemblies in a drying oven.

In still another aspect, the method further includes, after the submerging step, placing the first and second film/substrate assemblies on vacuum plates and imprinting first and second meshes respectively to the uncovered portions of the first and second acid-doped polybenzimidazole films.

Another embodiment comprises a method of preparing a first film/substrate assembly for bonding to another film/substrate assembly. The method includes attaching a pair of substrates to opposing surfaces of a first acid-doped polybenzimidazole film to form a first film/substrate assembly. A portion of the first acid-doped polybenzimidazole film is uncovered by the first substrates. The method further includes submerging at least the uncovered portion of the first acid-doped polybenzimidazole film in a solvent to remove acid from at least the uncovered portion of the first acid-doped polybenzimidazole film and spraying a fluoroelastomer coating on at least one section of the uncovered portion of the first acid-doped polybenzimidazole film.

In one aspect, the solvent is deionized water. In a further aspect, the deionized water is at room temperature and the submerging step is performed for at least about forty seconds.

In another aspect, the method further includes, after the attaching step but before the submerging step, heating the first film/substrate assembly at a temperature of about 180° C. for about forty-five minutes.

In yet another aspect, the method further includes, after the spraying step, placing the first film/substrate assembly in a drying oven.

In still another aspect, the method further includes, after the submerging step, placing the first film/substrate assembly on a vacuum plate and imprinting a first mesh to the uncovered portion of the first acid-doped polybenzimidazole film.

### BRIEF DESCRIPTION OF THE SEVERAL VIEWS OF THE DRAWINGS

The following detailed description of preferred embodiments will be better understood when read in conjunction with the appended drawings. For the purpose of illustration, there are shown in the drawings embodiments which are presently preferred. It should be understood, however, that the invention is not limited to the precise arrangements and instrumentalities shown.

In the drawings:

FIG. 1 is a flow diagram of an example method in accordance with a first example embodiment of the present invention; and

FIGS. 2A-2C are schematic diagrams of some of the components and materials utilized at various steps of the method provided in FIG. 1.

### DETAILED DESCRIPTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the device and designated parts thereof. The terminology includes the above-listed words, derivatives thereof, and words of similar import. Additionally, the words “a” and “an”, as used in the claims and in the corresponding portions of the specification, mean “at least one.”

It should also be understood that the terms “about,” “approximately,” “generally,” “substantially” and like terms, used herein when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

It will also be understood that terms such as “first,” “second,” and the like are provided only for purposes of clarity. The elements or components identified by these terms, and the operations thereof, may easily be switched.

Certain embodiments provided herein relate to a method for bonding together two or more acid-doped PBI films or membranes. More particularly, to a method for bonding together two or more acid-doped polymer films or membranes which have been fabricated by a sol-gel process, preferably utilizing PPA, and more preferably which have been synthesized via the PPA process. Even more particularly, to a method for bonding together two or more PA-doped polymer films or membranes which have been synthesized via the PPA process. While the discussion below relates to a scenario of bonding together two such films or membranes, it will be understood that the method may be repeated or duplicated as necessary to bond together additional films or membranes. Also, while the discussion below primarily refers to a polymer membrane, it will be understood that the method is fully applicable to any polymer film.

In the PPA process, PPA is utilized as both the poly-condensation reagent and the casting solvent in the fabrication of the highly acid doped-PBI membrane. The acid-doped PBI membranes are very hygroscopic due to the presence of the acid. As such, when the acid-doped PBI membrane is exposed to ambient air, a layer of water forms on the exposed surface of the membrane, thereby making it extremely difficult to bond the PBI membrane to anything, including to another PBI membrane.

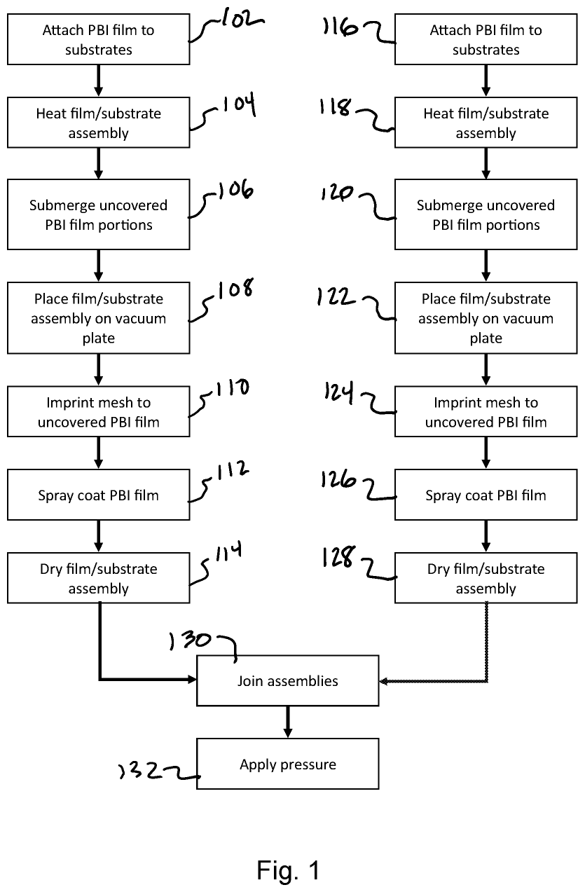

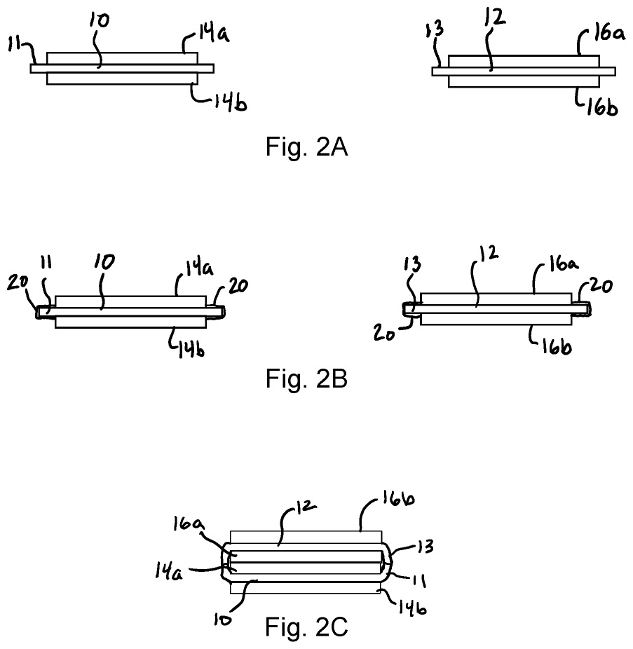

Referring to FIGS. 1 and 2A-2C, first and second acid-doped PBI films or membranes 10, 12 may be formed. In one embodiment, the polymer of the membranes 10, 12 is poly-2,2″-(m-phenylene)-5,5″-bibenzimidazole (m-PBI) or poly[2,2′-(p-phenylene)-5,5′-bibenzimidazole] (p-PBI). Preferably, each film or membrane 10, 12 may be an acid-doped p-PBI film or membrane. In one embodiment, the first and second acid-doped PBI films or membranes 10, 12 are formed by the PPA process.

In some embodiments, at step 102, the first PBI film 10 may be attached to a pair of first substrates 14a, b to form a first film/substrate assembly. For forming an MEA, the substrates 14a, b may be carbon-based electrodes, although other types of substrates, including multi-layer substrates, may be used as well. To attach the first PBI film 10 to a carbon-based electrode substrate, the substrate 14a, b may be hot pressed into the first PBI film 10 at a temperature of about 160° C. and a compression of not greater than about 30%.

The attachment may leave a portion 11 of the first PBI film 10 uncovered by the first substrates 14a, b. For example, each of the first substrates 14a, b may have a surface area that is smaller than a surface area of the first PBI film 10 such that when the first substrates 14a, b are attached (with aligned centers, for example), a periphery of the first PBI film 10 may extend beyond the edges of the first substrates 14a, b. For example, the uncovered portion 11 of the first PBI film 10 may extend about one inch beyond edges of the first substrates 14a, b, although the amount may vary depending on various factors, including thicknesses of the various layers and the like. While in some embodiments the uncovered portion 11 of the first PBI film may extend out from the first substrates 14a, b in all directions, although the uncovered portion 11 may be shaped and configured as needed to allow for bonding. For example, with rectangularly-shaped substrates 14a, b, the uncovered portion 11 may exist only on two opposing sides of the rectangle, rather than all four, if desired.

Once the first film/substrate assembly is formed, at step 104, it may then be heated, such as by being placed in an oven at a temperature of about 180° C. for about forty-five minutes, although other temperatures and durations may be used as well. This process pre-shrinks the first film/substrate assembly.

At step 106, at least the uncovered portion 11 of the first PBI film 10 may be submerged into a solvent in order to leach or otherwise remove acid (e.g., the PA) from at least the uncovered portion 11. This may be performed by submerging the entire first film/substrate assembly in the solvent, or just enough to immerse the uncovered portion 11 in the solvent. Alternatively, various edges of the uncovered portion 11 of the first PBI film 10 may be sequentially dipped into the solvent to avoid excessive contact of the first substrates 14a, b with the solvent. The solvent may be deionized water at room temperature, although other solvents and/or temperatures may be used as well depending on the nature of the PBI film and the acid(s) desired to be removed from the edges. The aim of the solvent is typically not to remove all of the acid and densify or otherwise harden the uncovered portion 11 of the first PBI film 10. Thus, when submerging the edges of the first film/substrate assembly in deionized water, the edges may be submerged each for at least about forty seconds or on the order of minutes, unlike other processes that remove the acid entirely by submerging the PBI film for hours.

At step 108, the first film/substrate assembly may be placed on a vacuum plate (not shown) having a mesh attached (e.g., welded or the like) thereto. At step 110, the mesh is imprinted to the uncovered portion 11 of the first PBI film 10 and the first film/substrate assembly may sit on the vacuum plate for at least about seven minutes. The mesh serves to etch or otherwise roughen the surface of the uncovered portion 11 to aid in the bonding process. Other etching/roughening processes may be used in addition to the mesh or alternatively. The vacuum plate may be used to ensure the PBI film stays flat during processing, so other like restraining methods can be used instead, if needed.

At step 112, at least one section of the uncovered portion 11 of the first PBI film 10 may be spray coated with a fluoroelastomer. An example of a coating layer 20 enclosing the uncovered portion 11 of the first PBI film 10 may be seen in FIG. 2B. Although the coating is shown residing only on the first PBI film 10, it is possible that the coating 20 may also be applied on portions of the first substrates 14a, b as well. The fluoroelastomer may be a VITON® spray commercially available from the Chemours Company, although other types of like fluoroelastomer sprays may be used as well. When spray coating, it is preferable to dispose the first film/substrate assembly under a fume hood. While the entirety of the uncovered portion 11 of the first PBI film 10 in FIG. 2B is shown covered by the coating layer 20, the coating layer 20 may be selectively applied to various sections of the uncovered portion 11 instead. For example, only the upward (or downward) facing surface of the uncovered portion 11 of the first PBI film 10 may be coated, the coating layer 20 may be provided only in select intervals along the uncovered portion, or other coating patterns may be used as well, depending on the configuration, materials, and/or bonding strategy.

At step 114, after the spray coating 20 is applied, the first film/substrate assembly may be dried, for example, in a drying oven at about 100° C. for at least about ten minutes, although other times and/or temperatures may be used as well.

Steps 102-114 constitute an example method of preparing the first film/substrate assembly for bonding to another. Steps 116-128 shown in FIG. 1 are similar to steps 102-114 and may be performed on a second or subsequent film/substrate assembly, such as the one shown in FIGS. 2A-2B having a second PBI film 12 sandwiched between second substrates 16a, b and providing an uncovered portion 13 that is submerged and coated. Steps 116-128 may be performed in parallel with steps 102-114, after steps 102-114, interleaved with steps 102-114, combinations thereof, or the like. Additional film/substrate assemblies may also be created and processed in like manner.

At step 130, the first and second substrate assemblies may be joined together. In particular, as seen in FIG. 2C, the second film/substrate assembly may be positioned atop the first film/substrate assembly. At least the spray-coated sections of the uncovered portions 11, 13 of the first and second PBI films 10, 12 may be brought into contact with each other, e.g., by bending or otherwise manipulating the uncovered portions 11, 13 of the first and second PBI films 10, 12. It should be mentioned that in some embodiments, the coating layer 20 need only be on one of the PBI films 10, 12 when the two uncovered portions 11, 13 are contacted, such as in a situation where only one of the PBI films 10, 12 is spray coated, or where the coating layer 20 is patterned (e.g., sections of the uncovered portion 11 of the first PBI film 10 having the coating layer 20 contact sections of the uncovered portion 13 of the second PBI film 12 without the coating layer 20 and vice versa), or the like.

At step 132, at least one of pressure or heat may be applied to the contacted sections of the uncovered portions 11, 13 of the first and second PBI films 10, 12 to create the bond. In one embodiment, the step includes applying pressure to the contacted sections for a period of about 24-48 hours, or until such time as the materials have bonded together. In another embodiment, the step includes applying a hot press (not shown) at a temperature of about 60° C. for about three minutes, although other times and/or temperatures may be used as well depending on the materials and conditions. The intervening fluoroelastomer coating better enables the bonding between the first and second (and additional) PBI films.

While the invention has been described above and illustrated in the drawings as being used with PBI films sandwiched by a pair of substrates, the methods disclosed herein, or minor variations thereof, may also be used on PBI films attached to a single substrate or more than two substrates. Methods disclosed herein, or minor variations thereof, may also be used on PBI films not attached to any substrates.

Those skilled in the art will recognize that boundaries between the above-described operations are merely illustrative. The multiple operations may be combined into a single operation, a single operation may be distributed in additional operations and operations may be executed at least partially overlapping in time. Further, alternative embodiments may include multiple instances of a particular operation, and the order of operations may be altered in various other embodiments.

While specific and distinct embodiments have been shown in the drawings, various individual elements or combinations of elements from the different embodiments may be combined with one another while in keeping with the spirit and scope of the invention. Thus, an individual feature described herein only with respect to one embodiment should not be construed as being incompatible with other embodiments described herein or otherwise encompassed by the invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A method of bonding two or more acid-doped polybenzimidazole films, the method comprising:
attaching a pair of first substrates to opposing surfaces of a first acid-doped polybenzimidazole film to form a first film/substrate assembly, wherein a portion of the first acid-doped polybenzimidazole film is uncovered by the first substrates, and attaching a pair of second substrates to opposing surfaces of a second acid-doped polybenzimidazole film to form a second film/substrate assembly, wherein a portion of the second acid-doped polybenzimidazole film is uncovered by the second substrates;
submerging at least the uncovered portions of the first and second acid-doped polybenzimidazole films in a solvent to remove acid from at least the uncovered portions of the first and second acid-doped polybenzimidazole films;
spraying a fluoroelastomer coating on at least one section of each of the uncovered portions of the first and second acid-doped polybenzimidazole films;
positioning the second film/substrate assembly atop the first film/substrate assembly and bringing the spray coated sections of the uncovered portions of the first and second acid-doped polybenzimidazole films into contact with each other; and
applying at least one of pressure or heat to the contacted sections of the uncovered portions of the first and second acid-doped polybenzimidazole films.

2. The method of claim 1, wherein the solvent is deionized water.

3. The method of claim 2, wherein the deionized water is at room temperature and the submerging step is performed for at least about forty seconds.

4. The method of claim 1, wherein the step of applying at least one of pressure or heat includes applying pressure to the contacted sections for a period of about 24-48 hours.

5. The method of claim 1, wherein the step of applying at least one of pressure or heat includes applying a hot press at a temperature of about 60° C. for about three minutes.

6. The method of claim 1, further comprising, after the attaching step but before the submerging step, heating the first and second film/substrate assemblies at a temperature of about 180° C. for about forty-five minutes.

7. The method of claim 1, further comprising, after the spraying step, drying the first and second film/substrate assemblies in a drying oven.

8. The method of claim 1, further comprising, after the submerging step, placing the first and second film/substrate assemblies on vacuum plates and imprinting first and second meshes respectively to the uncovered portions of the first and second acid-doped polybenzimidazole films.

9. A method of preparing a first film/substrate assembly for bonding to another film/substrate assembly, the method comprising:
attaching a pair of substrates to opposing surfaces of a first acid-doped polybenzimidazole film to form a first film/substrate assembly, wherein a portion of the first acid-doped polybenzimidazole film is uncovered by the first substrates;
submerging at least the uncovered portion of the first acid-doped polybenzimidazole film in a solvent to remove acid from at least the uncovered portion of the first acid-doped polybenzimidazole film; and
spraying a fluoroelastomer coating on at least one section of the uncovered portion of the first acid-doped polybenzimidazole film.

10. The method of claim 9, wherein the solvent is deionized water.

11. The method of claim 10, wherein the deionized water is at room temperature and the submerging step is performed for at least about forty seconds.

12. The method of claim 9, further comprising, after the attaching step but before the submerging step, heating the first film/substrate assembly at a temperature of about 180° C. for about forty-five minutes.

13. The method of claim 9, further comprising, after the spraying step, placing the first film/substrate assembly in a drying oven.

14. The method of claim 9, further comprising, after the submerging step, placing the first film/substrate assembly on a vacuum plate and imprinting a first mesh to the uncovered portion of the first acid-doped polybenzimidazole film.
